(19) United States
(12) Patent Application Publication
(10) Pub. No.: US 2013/0284814 A1
(43) Pub. Date: Oct. 31, 2013

(54) RADIO FREQUENCY IDENTIFICATION RIVET

(71) Applicant: PO-WEI HUANG, KAOHSIUNG CITY (TW)

(72) Inventor: PO-WEI HUANG, KAOHSIUNG CITY (TW)

(21) Appl. No.: 13/455,903

(22) Filed: Apr. 25, 2012

(51) Int. Cl. G06K 19/067

(52) U.S. Cl. 235/492

(57) ABSTRACT

A radio frequency identification rivet at least includes a rivet consisting of two or more interlocking devices, or a single locking device, with a radio frequency identification system installed in the rivet. So any object jointed with the rivet can not only be identified with radio frequency, but also attain anti-theft and anti-counterfeit purposes, unless the rivet is forcefully damaged taken off the object.

### BACKGROUND OF THE INVENTION

1. Field of the Invention

This invention relates to a radio frequency identification rivet, particularly to one able to be jointed with objects to work with anti-theft and anti-counterfeit functions.

2. Description of the Prior Art

As disclosed in Taiwan Patent No. M355918 (Anti-Counterfeit Cap), it is to identify if the anti-counterfeit cap is opened or not, taking advantage of a third antenna to electrically connect with a first or a second antenna to tell if data stored in the radio frequency identification tag can be read. However, for costly bottled products such as drugs, chemical compounds or raw materials, more necessarily, they have to be prevented from being stolen in addition to worrying about if the cap is opened or not. And in order to break down induction of the radio frequency identification system, a thief may use tools or thermo measures (such as a microwave oven for trial in a supermarket) to destroy the radio frequency identification system for losing anti-theft effect. Moreover, when a conventional counterfeit cap is opened, the third antenna always cannot be torn off the second antenna, unable to promptly interrupt radio frequency identification signals to carry out anti-counterfeit effect.

And if the cap is made of metals or what is contained in the bottle is a liquid, they may interfere with signals to be accepted by the antenna of the radio frequency identification system; or if the radio frequency identification system is attached on the cap, a poor identification always happens.

Moreover, all of conventional radio frequency identification systems may work problematically if combined with flexible objects (such as a dropping bottle or a dropping bag).

### SUMMARY OF THE INVENTION

The object of this invention is to offer a radio frequency identification rivet that can be jointed with objects, such as metallic objects, liquid containers, clothing or bags etc, to completely execute anti-theft, anti-counterfeit and debug functions.

The radio frequency identification rivet mainly includes a rivet consisting of two or more interlocking devices, or a single locking device, with a radio frequency identification system installed in the rivet. So any object can be jointed with the rivet, not only be identified with radio frequency, but also attaining anti-theft, anti-counterfeit and debug functions.

### BRIEF DESCRIPTION OF DRAWINGS

This invention is better understood by referring to the accompanying drawings, wherein:

FIG. 1 is a partial exploded cross-sectional view of a first preferred embodiment of a radio frequency identification rivet in the present invention;

FIG. 2 is a partial exploded cross-sectional view of a second preferred embodiment of a radio frequency identification rivet in the present invention;

FIG. 3 is a cross-sectional view of a third preferred embodiment of a radio frequency identification rivet in the present invention;

FIG. 4 is a cross-sectional view of a fourth preferred embodiment of a radio frequency identification rivet in the present invention;

FIG. 5 is a cross-sectional view of a fifth preferred embodiment of a radio frequency identification rivet in the present invention;

FIG. 6 is a cross-sectional view of a sixth preferred embodiment of a radio frequency identification rivet in the present invention;

FIG. 7 is a cross-sectional view of a seventh preferred embodiment of a radio frequency identification rivet in the present invention;

FIG. 8 is a cross-sectional view of the seventh preferred embodiment of a radio frequency identification rivet in the present invention, showing a first example of jointing it with an object;

FIG. 9 is a cross-sectional view of the seventh preferred embodiment of a radio frequency identification rivet in the present invention, showing a second example of jointing it with an object;

FIG. 10 is a cross-sectional view of the seventh preferred embodiment of a radio frequency identification rivet in the present invention, showing a third example of jointing it with an object;

FIG. 11 is a cross-sectional view of an eighth preferred embodiment of a radio frequency identification rivet in the present invention;

FIG. 12 is a cross-sectional view of the eighth preferred embodiment of a radio frequency identification rivet in the present invention, showing an example of jointing it with an object;

FIG. 13 is a cross-sectional view of the eighth preferred embodiment of a radio frequency identification rivet in the present invention, showing another example of jointing it with an object;

FIG. 14 is a cross-sectional view of a ninth preferred embodiment of a radio frequency identification rivet in the present invention;

FIG. 15 is a cross-sectional view of the ninth preferred embodiment of a radio frequency identification rivet in the present invention, showing an example of jointing it with an object;

FIG. 16 is a cross-sectional view of a tenth preferred embodiment of a radio frequency identification rivet in the present invention;

FIG. 17 is a cross-sectional view of the tenth preferred embodiment of a radio frequency identification rivet in the present invention, showing an example of jointing it with an object;

FIG. 18 is a perspective view of an eleventh preferred embodiment of a radio frequency identification rivet in the present invention;

FIG. 19 is a perspective view of a twelfth preferred embodiment of a radio frequency identification rivet in the present invention;

FIG. 20 is a front view of the eleventh and the twelfth preferred embodiment of a radio frequency identification rivet in the present invention, showing it being jointed with a piece of clothing;

FIG. 21 is a front view of the eleventh and the twelfth preferred embodiment of a radio frequency identification rivet in the present invention, showing it being jointed with a bag;

FIG. 22 is a front view of the eleventh and the twelfth preferred embodiment of a radio frequency identification rivet in the present invention, showing it being jointed with a shoe;

FIG. 23 is an exploded perspective view of a thirteenth preferred embodiment of a radio frequency identification rivet in the present invention;

FIG. 24 is a cross-sectional view of the thirteenth preferred embodiment of a radio frequency identification rivet in the present invention; and

FIG. 25 is a cross-sectional view of a fourteenth preferred embodiment of a radio frequency identification rivet in the present invention.

### DETAILED DESCRIPTION OF THE PREFERRED EMBODIMENT

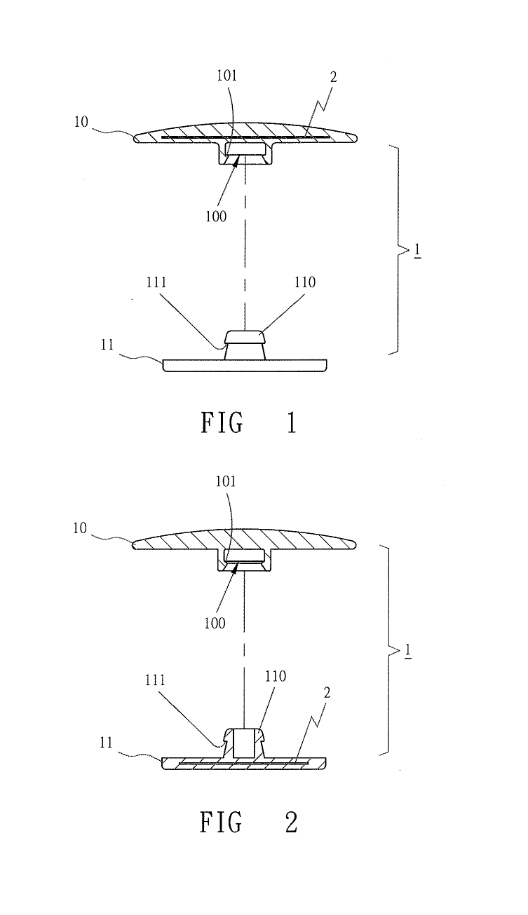

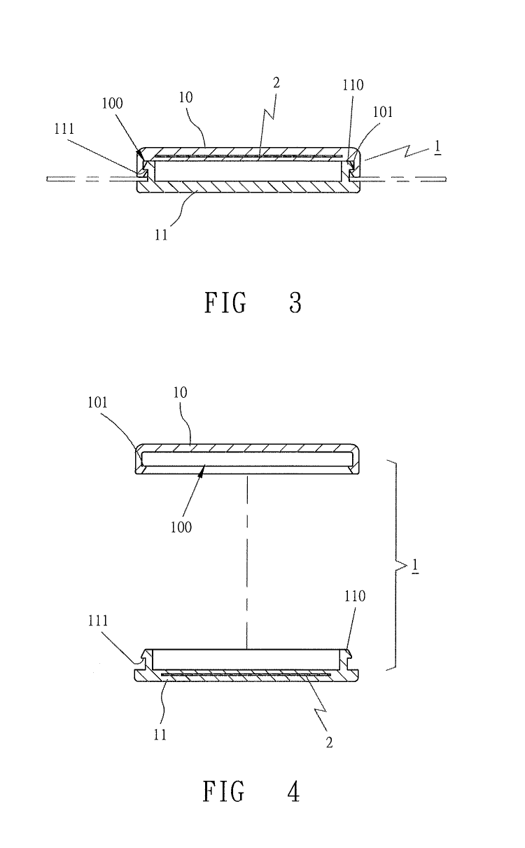

FIGS. 1-4 respectively show first four preferred embodiments of a radio frequency identification rivet in the present invention, mainly including a rivet 1 and a radio frequency identification system 2.

The rivet 1 is provided with two corresponding interlocking devices 10 and 11. The radio frequency identification system 2 is installed in the interlocking device 10 or 11, completely wrapped up while the interlocking device 10 or 11 is molded to prevent it from being damaged intentionally or unintentionally.

As shown in FIGS. 1-4, the interlocking devices 10 and 11 are combined together through diverse ways. The interlocking device 10 is bored with a joint groove 100 having an intermediate circumference shrunk inwards to form as an interlocking circumference 101. The interlocking device 11 possesses a joint base 110 having a front portion conically enlarged to form as an interlocking cone 111. As the joint base 110 of the interlocking device 11 is inserted in the joint groove 100 of the interlocking device 10, the interlocking circumference 101 of the interlocking device 10 is to restrictively contact with the interlocking cone 111 of the interlocking device 11, making the interlocking devices 10 and 11 combined as the rivet 1 and not apt to be separated or damaged.

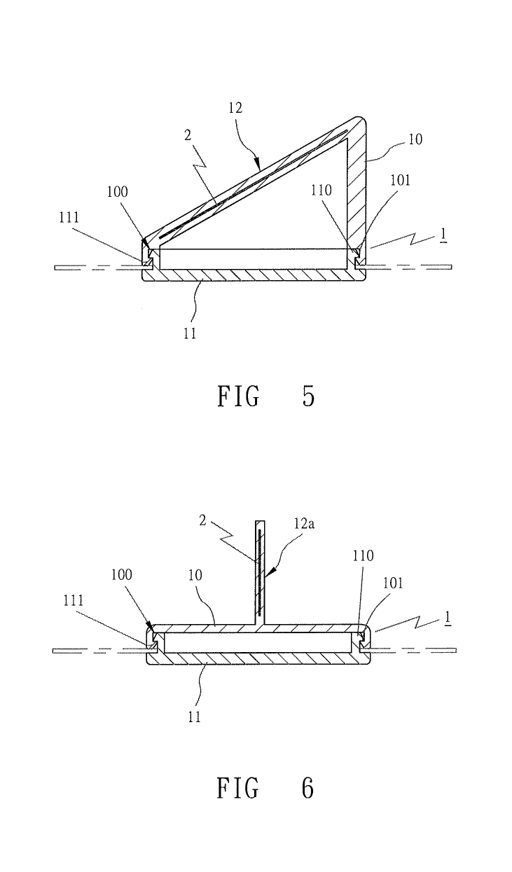

FIGS. 5 and 6 respectively show a fifth and a sixth preferred embodiment of the invention, with one of the interlocking devices 10 and 11 provided with a sloping surface 12 (as shown in FIG. 5) or a vertical surface 12a (as shown in FIG. 6). The radio frequency identification system 2 is buried within the sloping surface 12 or the vertical wall 12a to coordinate with disposal of a radio frequency identification equipment.

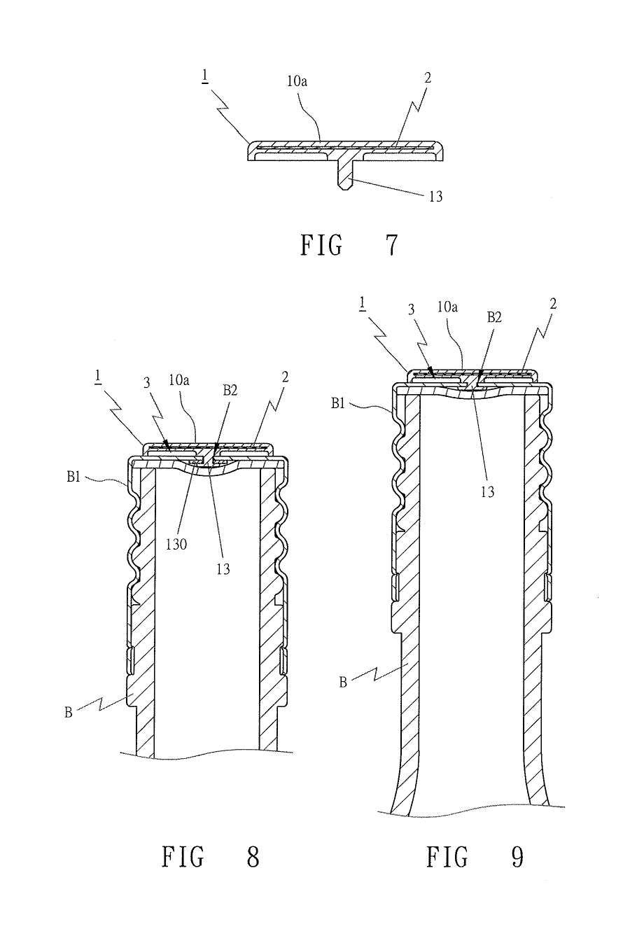

As shown in FIG. 7, a seventh preferred embodiment of a radio frequency identification rivet in the present invention includes a rivet 1 consisting of a single locking device 10a with an extension 13, with a radio frequency identification system 2 buried within the locking device 10a to prevent it from being damaged intentionally or unintentionally.

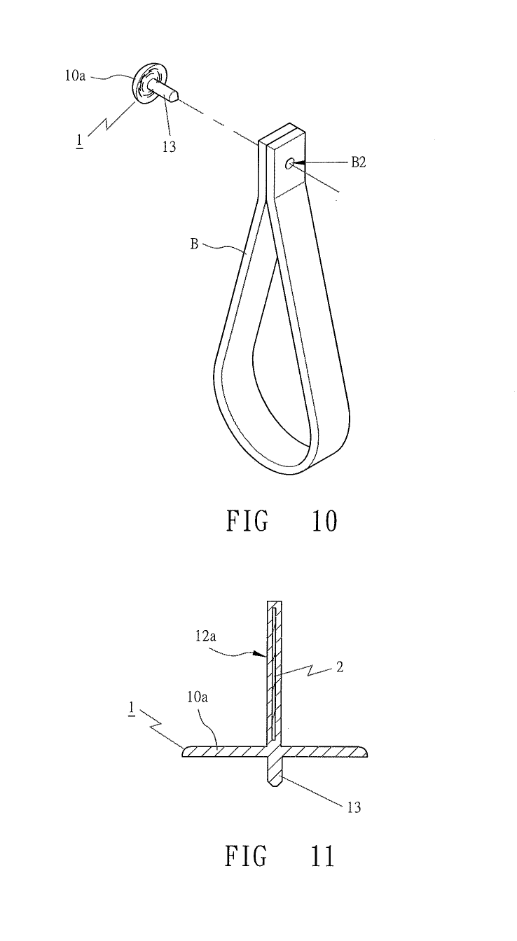

For application, as shown in FIGS. 8-10, the extension 13 is first inserted through an object B (as shown in FIG. 10) or a through hole B2 bored in its cap B1 (as shown in FIGS. 8 and 9). Then the free end of the extension 13 is deformed to deadly combine with the object B. As shown in FIG. 8, if necessary, an airtight seal 130 can be inserted before deforming the extension 13. If the object B or the cap B1 is made of metals, a space 3 must be properly kept to avoid the radio frequency identification system 2 from being interfered to downgrade anti-theft, anti-counterfeit and debug abilities.

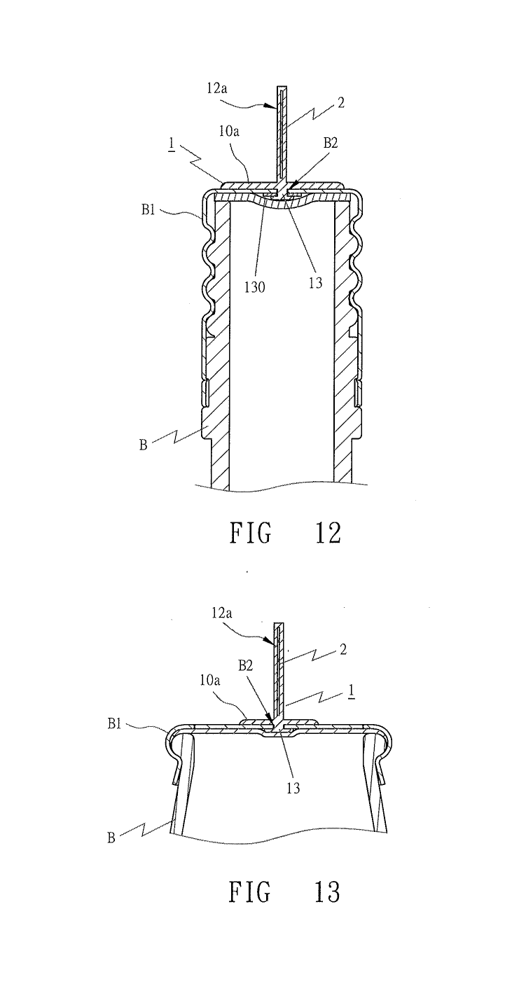

As shown in FIG. 11, an eighth preferred embodiment of a radio frequency identification rivet in the present invention includes a rivet 1 consisting of a single locking device 10a that has a vertical surface 12a buried with a radio frequency identification system 2 to prevent it from being damaged intentionally or unintentionally. An extension 13 is projected outwards opposite to the vertical surface 12a.

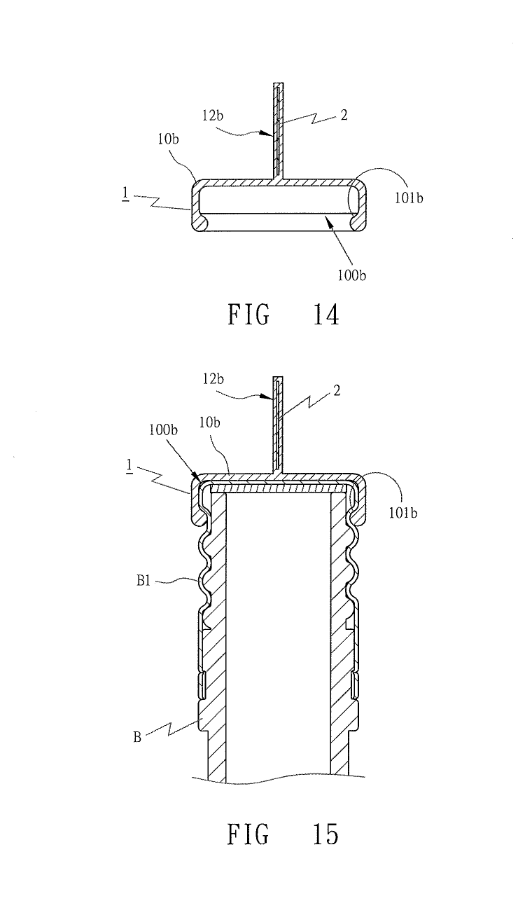

For application, as shown in FIGS. 12 and 13, the extension 13 is first inserted through a through hole B2 bored in a cap B1 of an object B. Then the free end of the extension 13 is deformed to deadly combine with the object B. As shown in FIG. 12, if necessary, an airtight seal 130 can be inserted before deforming the extension 13. So the object B can work with anti-theft, anti-counterfeit and debug functions.

As shown in FIG. 14, a ninth preferred embodiment of a radio frequency identification rivet in the present invention includes a rivet 1 consisting of a single locking device 10b that has a vertical wall 12b buried with a radio frequency identification system 2 to prevent it from being damaged intentionally or unintentionally. A joint groove 100b is recessed upwards under the vertical wall 12a, with the circumferential edge swollen inward to form as an interlocking circumference 101b.

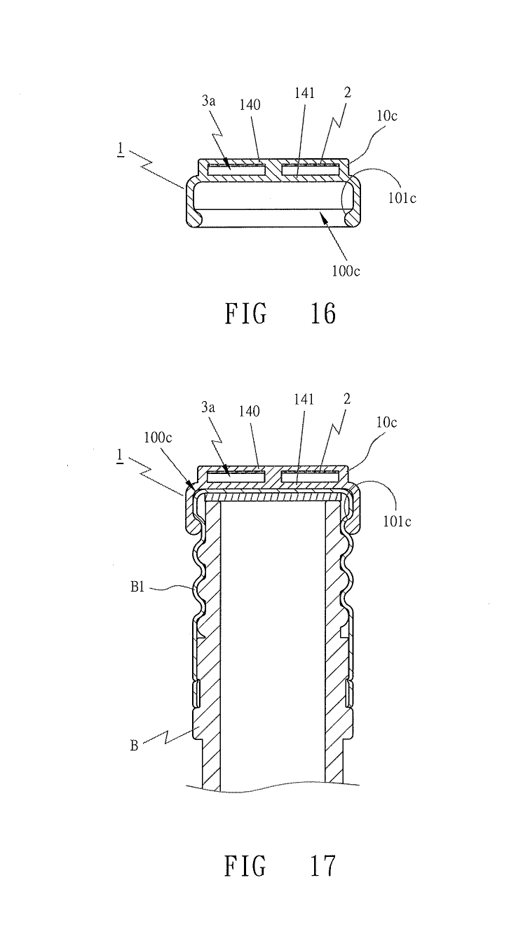

For application, as shown in FIG. 15, the joint groove 100b is fitted with an object B or its cap B1, with the interlocking circumference 101b restrictively contacting with the object B or the cap B1 to execute anti-theft, anti-counterfeit and debug functions.

As shown in FIG. 16, a tenth preferred embodiment of a radio frequency identification rivet in the present invention includes a rivet 1 consisting of a single locking device 10c that has an upper portion 140 buried with a radio frequency identification system 2 to prevent it from being damaged intentionally or unintentionally. A joint groove 100c is formed under the bottom of the locking device 10c, with the circumferential edge swollen inward to form as an interlocking circumference 101c. In addition, an isolation space 3a is formed between the upper portion 140 and a lower portion 141 to keep the radio frequency identification system 2 from being interfered by the object B.

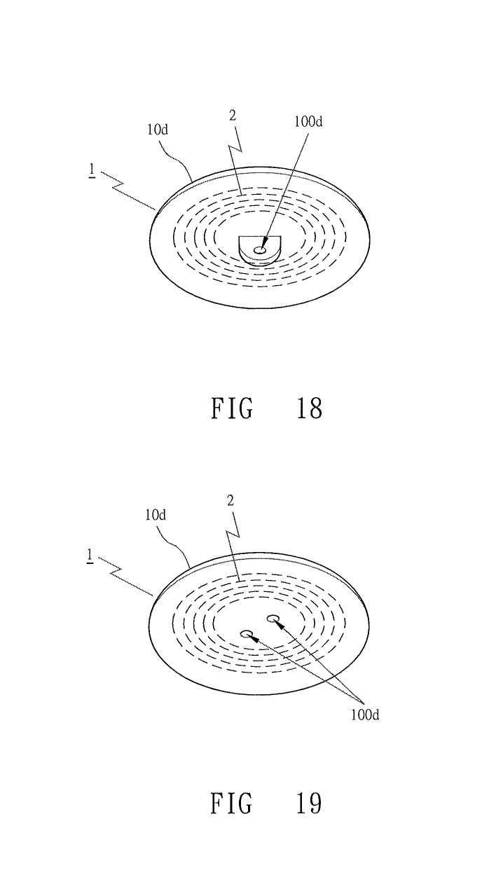

For application, as shown in FIG. 17, the joint groove 100c is fitted with an object B or its cap B1, with the interlocking circumference 101b restrictively contacting with the object B or the cap B1 to execute anti-theft, anti-counterfeit and debug functions.

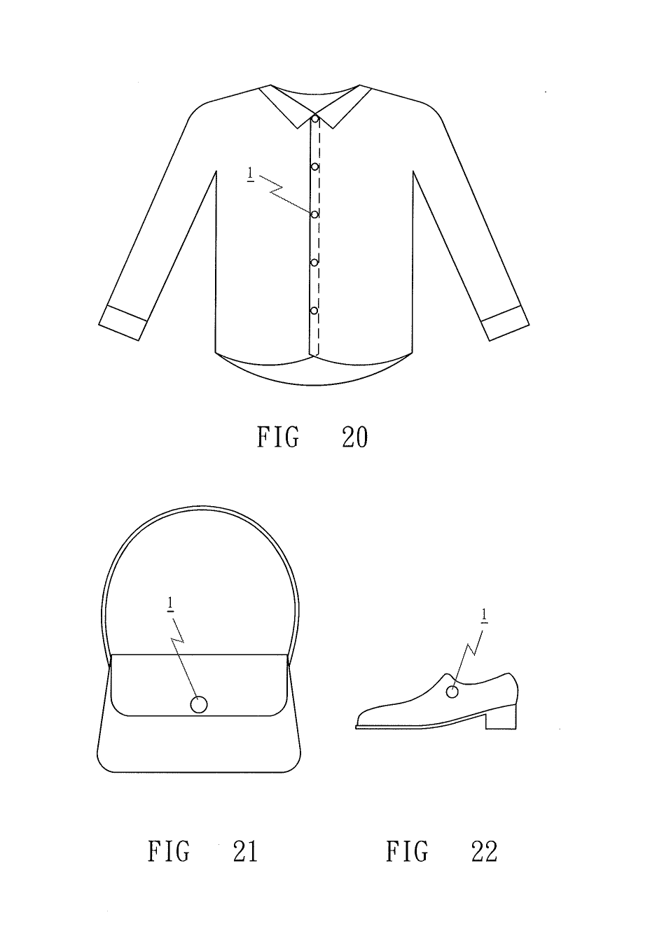

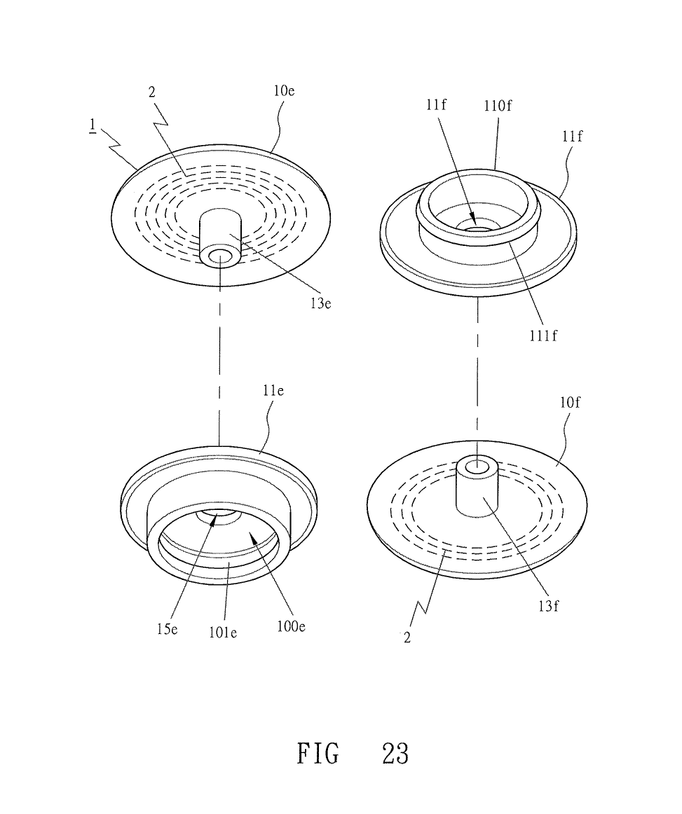

As shown in FIGS. 18 and 19, an eleventh and a twelfth preferred embodiment of a radio frequency identification rivet in the present invention includes a rivet 1 consisting of a single locking device 10d buried with a radio frequency identification system 2 to prevent it from being damaged intentionally or unintentionally. In addition, a joint base or hole 100d is provided to combine with flexible objects, such as clothing (FIG. 20), bags (FIG. 21) and shoes (FIG. 22), so that the rivet 1 can execute anti-theft, anti-counterfeit and debug functions.

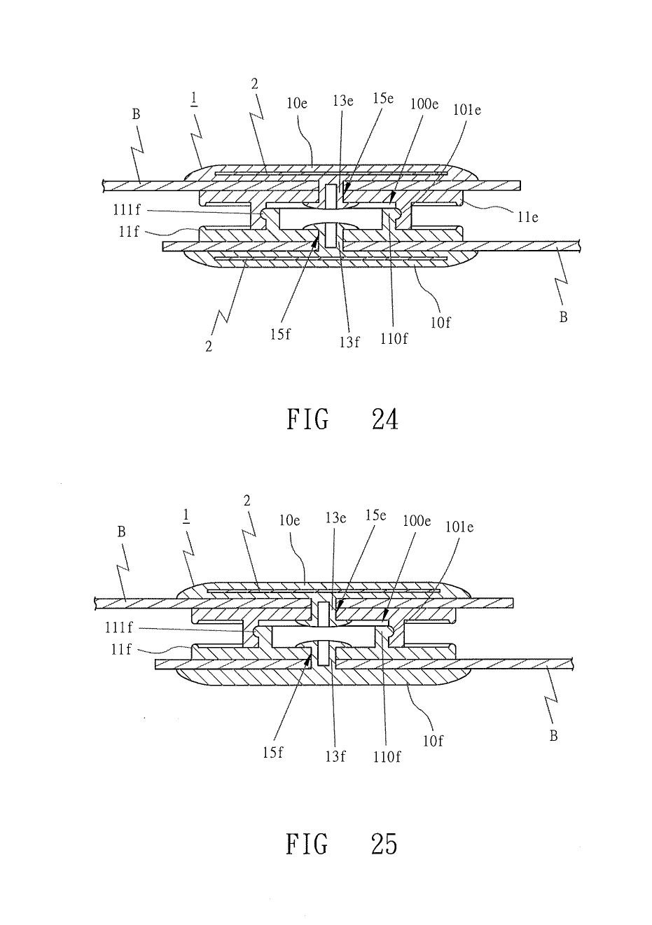

As shown in FIG. 23, a thirteenth preferred embodiment of a radio frequency identification rivet in the present invention includes a rivet 1 composed of plural paired interlocking devices 10e and 11e, and 10f and 11f, with both (FIG. 24) or either (FIG. 25) of the interlocking devices 10e and 10f buried with a radio frequency identification system 2 to prevent it from being damaged intentionally or unintentionally. The interlocking devices 10e and 11e are first assembled together to form as a first rivet and the interlocking devices 10f and 11f are next assembled together to form as a second rivet. Then the interlocking device 11e of the first rivet is jointed with the interlocking device 11f of the second rivet. Moreover, the interlocking devices 10e and 10f respectively have an extension 13e and 13f, and the interlocking devices 11e and 11f respectively have a hole 15e and 15f.

With the extension 13e of the interlocking device 10e inserted through the hole 15e of the interlocking device 11e, the free end of the extension 13e can be deformed to make the interlocking devices 10e and 11e deadly combined together, defined as the first rivet. And with the extension 13f of the interlocking device 10f inserted through the hole 15f of the interlocking device 11f, the free end of the extension 13f can be deformed to make the interlocking devices 10f and 11f deadly combined together, defined as the second rivet. The first rivet and the second rivet can be respectively jointed with an object B.

Furthermore, the interlocking device 11e is provided with a joint groove 100e having the inner wall recessed to form as an interlocking circumference 101e, and the interlocking device 11f is provided with a joint base 110f having the front portion conically expanded to form as an interlocking cone 111f. The joint groove 100e of the interlocking device 11e can engage with the joint base 110f of the interlocking device 11f, with the interlocking circumference 101e to immovably restrict the interlocking cone 111f, so that the object B can work with anti-theft, anti-counterfeit and debug functions.

Accordingly, any object jointed with the rivet of the invention can not only be anti-theft, but also be anti-counterfeit to prevent the rivet from being recycled.

While the preferred embodiment of the invention has been described above, it will be recognized and understood that various modifications may be made therein and the appended claims are intended to cover all such modifications that may fall within the spirit and scope of the invention.

What is claimed is:

1. A radio frequency identification rivet at least comprising:
a rivet provided with two or more corresponding interlocking devices or a single device, a radio frequency identification system installed in said interlocking devices, said rivet able to be jointed with any object to work with anti-theft, anti-counterfeit and debug functions.

2. The radio frequency identification rivet as claimed in claim 1, wherein said rivet consists of two corresponding interlocking devices and said radio frequency identification system is buried within one or both of said interlocking devices while molding said interlocking devices.

3. The radio frequency identification rivet as claimed in claim 2, wherein said rivet consists of two said interlocking devices, one of said interlocking devices bored with a joint groove having an intermediate circumference shrunk inwards to form as an interlocking circumference, another interlocking device possessing a joint base having a front portion conically enlarged to form as an interlocking cone, said joint base inserted in said joint groove to enable said interlocking circumference to restrictively contact with said interlocking cone so as to make said interlocking devices combined together as said rivet.

4. The radio frequency identification rivet as claimed in claim 2, wherein one of said interlocking devices is provided with a sloping wall buried with said radio frequency identification system.

5. The radio frequency identification rivet as claimed in claim 2, wherein one of said interlocking devices is provided with a sloping wall buried with said radio frequency identification system.

6. The radio frequency identification rivet as claimed in claim 1, wherein said rivet consists of a single locking device buried with said radio frequency identification system and provided with an extension.

7. The radio frequency identification rivet as claimed in claim 6, wherein said extension of said locking device is to penetrate an object or its cap and has a free end deformed to make said locking device deadly jointed with said object.

8. The radio frequency identification rivet as claimed in claim 7, wherein an airtight seal is added before a free end of said extension is deformed.

9. The radio frequency identification rivet as claimed in claim 7, wherein said rivet is separated from said object or its cap with a proper space to avoid said radio frequency identification system from being interfered.

10. The radio frequency identification rivet as claimed in claim 6, wherein said locking device is provided with a vertical wall buried with said radio frequency identification system.

11. The radio frequency identification rivet as claimed in claim 6, wherein said locking device is bored with a joint groove having a circumferential edge swollen inward to form as an interlocking circumference that can restrictively contact with an object or its cap to execute anti-theft, anti-counterfeit and debug functions.

12. The radio frequency identification rivet as claimed in claim 6, wherein said locking device has an upper portion buried with said radio frequency identification system and a joint groove formed in a bottom with a circumferential edge swollen inward to form as an interlocking circumference, an isolation space located between said upper portion and a lower portion to keep said radio frequency identification system from being interfered by said object.

13. The radio frequency identification rivet as claimed in claim 6, wherein said locking device is provided with a joint base or hole to combine with flexible objects so as to execute anti-theft, anti-counterfeit and debug functions.

14. The radio frequency identification rivet as claimed in claim 1, wherein said rivet is composed of four interlocking devices divided into two pairs, each pair or only one pair having one interlocking device buried with a radio frequency identification system, said interlocking devices of each pair being first combined together to form as a first rivet and a second rivet, said first rivet and said second rivet next combined together to form as a double rivet.

15. The radio frequency identification rivet as claimed in claim 14, wherein one of said interlocking devices of said first rivet has an extension inserted through a hole bored in another interlocking device and one of said interlocking devices of said second rivet has an extension inserted through a hole bored in another interlocking device, each extension of said first rivet and said second rivet having a free end deformed to make each pair of interlocking devices of said first rivet and said second rivet deadly combined together, one of said interlocking devices of said first rivet provided with a joint groove having an inner wall recessed to form as an interlocking circumference, one of said interlocking devices of said second rivet provided with a joint base having a front portion conically expanded to form as an interlocking cone, said joint groove of said first rivet able to be deadly engaged with said joint base owing to said interlocking circumference of said first rivet immovably restricting said interlocking cone of said second rivet so as to execute anti-theft, anti-counterfeit and debug functions for objects jointed with said rivet.
